(19) United States
(12) Patent Application Publication
(10) Pub. No.: US 2025/0033060 A1
(43) Pub. Date: Jan. 30, 2025

(54) MEDIA COLUMN FOR AN ARRANGEMENT FOR DISTRIBUTING MEDIA SUCH AS GASEOUS AND LIQUID MEDIA, VACUUM, POWER AND COMMUNICATION IN A LABORATORY

(71) Applicant: H. LÜDI + CO. AG, Regensdorf (CH)

(72) Inventor: Hansjürg LÜDI, Wollerau (CH)

(21) Appl. No.: 18/714,214

(22) PCT Filed: Nov. 29, 2022
(86) PCT No.: PCT/EP2022/083604

§ 371 Date: May 29, 2024

(30) Foreign Application Priority Data
Nov. 29, 2021 (DE) 10 2021 131 228.0

(51) Int. Cl. B01L 9/02; F24F 7/08

(52) U.S. Cl. CPC B01L 9/02; F24F 7/08; B01L 2200/026

(57) ABSTRACT

A media column for distributing media in a laboratory with workbenches having worktops and rear longitudinal edge. The column has a vertical support body with a front face receiving a releasably fastened module element to which the media can be fed via feed lines. The module element has a housing with a front face accommodating a removal valve for outputting media. The column has a vertically elongated rigid profile fastened by a first lower end to the upper face of a standing platform. One module element, on the front face of the profile, is a distance from the upper face of the standing platform such that the underside of the housing is a distance above a worktop. The housing protrudes over the worktop. Feed lines for the media have flexible line portions from the second upper end of the profile to a supply point for the media on the ceiling.

The invention relates to a media column for distributing media such as gaseous and liquid media, vacuum, power and communication, in a laboratory, and to an assembly for workbenches comprising such a media column for a laboratory or an office, according to the preamble of claims 1 and 8.

In building technology, for fitting out research laboratories such as for chemistry of physics research, it is known that ceiling constructions are used in which the supply lines for exhaust air, supply air, the technical gases, liquids, power and data lines required in the laboratory, etc. are fastened directly to the associated building ceiling, inside the ceilings, with the aid of suitable fastening means, by means of dowels. Since in this case the laying of the lines is generally carried out successively by different staff, the difficulty arises that the route of the lines is sometimes not only criss-cross and alternately in a plurality of planes, but rather in addition the individual mounting of the fastening devices means that spatial changes to an existing laboratory arrangement can be undertaken retrospectively only with great effort.

A ceiling construction for a laboratory room is known from EP 1 934 414 B1, in which the gaseous and liquid media and also electricity are conducted in an ordered manner in main supply lines, extending in parallel with one another, in the region of the laboratory ceiling, which lines are received in a carrier frame composed of profile supports. The different media are conducted from the main supply lines, via flexible branch lines which can be connected to the supply lines via quick couplings, to the respective suspended media columns, which are received above the laboratory benches, at the corresponding workplaces, on the underside of the carrier frame.

Although the above-described ceiling construction offers a plurality of advantages compared with conventional laboratory ceilings having disordered guidance of the media lines, the problem arises in this case that the supply of the respective workplaces takes place exclusively via the suspended media columns, and the supply of the media to the fixtures on the laboratory benches is carried out not via the bench itself but rather merely via the lines hanging down from the media columns.

DE 1857988 U1 describes an assembly for supplying laboratory workplaces with various media, comprising a fixedly arranged narrow wall element, which is arranged between vertical profiles. In the wall element the respective media, which are supplied to the wall element, within the profiles, from the ceiling of the laboratory, are conducted in horizontal lines that are arranged one above the other in parallel and from which stitch pipelines extend to the taps for the media which are located above the respective laboratory benches and which are arranged between the respective vertically extending support profiles in boxes on the back of the wall elements. On account of the construction, the described assembly is laborious to mount and has little flexibility in view of retrospective positioning of the fittings and taps for outputting the media, on the wall element.

An assembly for supplying gaseous and liquid media, vacuum, power and communication to the workplaces, arranged in rows, in a laboratory, is known from DE 10 2019 119 116, which assembly comprises at least one stationary modular wall element to which the media are supplied, from the main supply lines extending in the region of the ceiling of the laboratory, via vertical supply lines. The wall element, along which the workplaces are arranged in one row or also in two rows back-to-back, and which can be of a width of e.g. 100 mm or 200 mm and a height of e.g. 90 cm, and a length of for example 90, 120, 150 and 180 cm, comprises a back on its upper side, on which back one or also more media boxes can be arranged, which each comprise different extraction fittings for the various media, via which said media can be output for use in the laboratory.

In the case of the described assemblies for media supply in laboratories, the problem arises that said assemblies can be positioned at different locations in the laboratory only with great effort, since the media columns and media boxes have to be mechanically detached from the respective holding devices, these have to be shifted to the desired new position, while simultaneously also guiding the supply lines, and, upon completion, the media boxes or media columns have to be mechanically fixed again to the respective holding device, in the new position. In this case, the fact that, during relocation, the media columns sometimes also have to be raised over the laboratory benches, constitutes a further difficulty.

Accordingly, an object of the present invention is to provide a media column for distributing media in a laboratory, which can be positioned flexibly, within a very short time, at different positions along a row of workbenches in a laboratory.

This object is achieved according to the invention by a media column having the features of claim 1.

A further object of the invention consists in providing an assembly of workbenches in a laboratory which allows flexible positioning, without tools, of the media, required within a laboratory, in the region of the workbenches.

This object is achieved according to the invention by an assembly having the features of claim 8.

Further features of the invention are described in the dependent claims.

According to the invention, a media column for distributing media, in particular gaseous and liquid media such as technical gases, water and coolant, vacuum, power and communication in a laboratory, which preferably contains a plurality of workbenches arranged in rows which in each case have a worktop having a rear longitudinal edge, a carrier body which extends in the vertical direction and on the front side of which at least one module element is detachably fastened, to which the gaseous and/or liquid media can be supplied via supply lines, and which has a housing having a front side in which at least one extraction fitting is received, via which the media can be output. The invention is likewise intended to cover the situation where the module elements can contain interfaces for data processing devices, e.g. modems, routers or switches, which can be connected to the respective EDP devices via data sockets arranged on the front side or the side walls of the housing of the module elements, and which are primarily connected via a wireless network for data communication.

The media column according to the invention is characterised in that the carrier body is a flat, inherently rigid profile which is elongated in the vertical direction, in particular a metal profile, e.g. an aluminium hollow profile having a rectangular cross-section or outside cross-section. It is likewise possible for the carrier body to comprise two such profiles, which can be interconnected for example via struts or the like. The elongated profile, which can be for example of a length of 2.3 m, a depth of 20-50 mm and a width of 150 mm, is fastened by its first lower end, in a standing manner, on the upper side of a standing platform, which preferably has a rectangular cross-section and can be configured for example as a flat metal plate or as a metal hollow profile, which is deposited on the floor of the laboratory and forms the base, as it were, of the media column according to the invention.

The standing platform can for example be of a depth of 200 mm to 300 mm, and be additionally loaded with weights, in order to ensure secure standing of the media column. Viewed in cross-section from the side, the standing platform protrudes at right-angles from the elongated profile fastened thereon. In this case, the depth of the elongated profile and the depth of the standing platform, and also the position at which the lowest module element is fastened on the profile are selected, depending on the height of the workbench, which is typically 65 to 95 cm from the floor to the upper side of the worktop, in such a way that the underside of the housing of the lowest extraction module is located at a small spacing of e.g. 10 mm, or also more, above the worktop of the workbench(es), which are preferably arranged one behind the other along rows in the laboratory. In this case, the housing of the lowest extraction module, and also the further module elements optionally arranged thereabove, which for example have a depth of 160 mm, protrudes beyond the worktop in the region of its rear longitudinal edge, such that the media column, formed in this way, surrounds the worktop in the region of the rear longitudinal edge, viewed from the side, and the media column can be positioned at a desired position along the rear longitudinal edge.

In order to supply the extraction fittings in the module elements with the desired media, according to the invention the supply lines for the media comprise flexible line portions which are preferably guided, from the second upper end of the inherently rigid profile, in a convex curve on its upper side, to a ceiling-side supply point of the laboratory for the media. From here, the media, in particular the gaseous and liquid media, as well as a vacuum, are supplied to the respective workplaces, preferably via flexible metal lines.

The invention results in the advantage that the adjustment of the supply of the workplaces with the necessary media, in the case of a reconfiguration of a workplace in a laboratory, can take place significantly more flexibly, without experienced technicians and fitters, and lifting equipment, being required, which have to mechanically detach the media column from the retainers, transfer it, and fasten it again, as is required in the case of known media columns, which are received suspended on the building ceiling or a ceiling grid of a laboratory.

The invention will be described in the following, with reference to the drawings and on the basis of preferred embodiments. In the drawings:

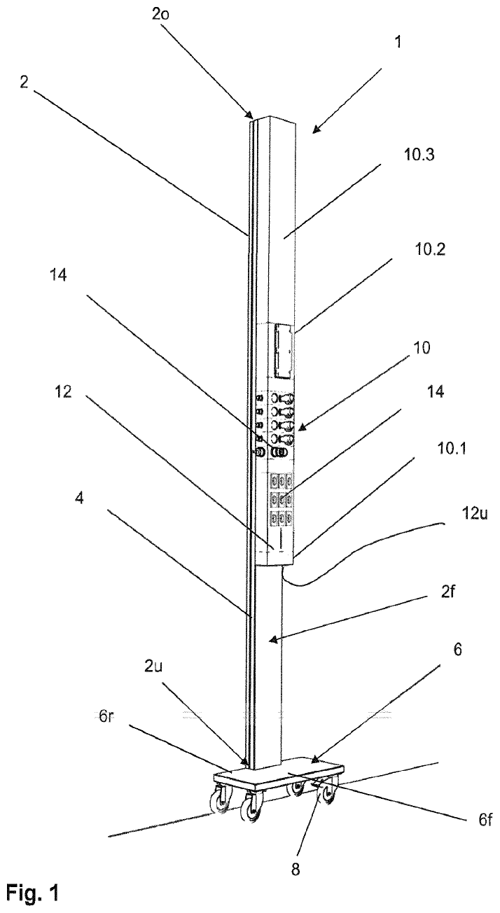

FIG. 1 is a schematic three-dimensional view of the media column according to the invention,

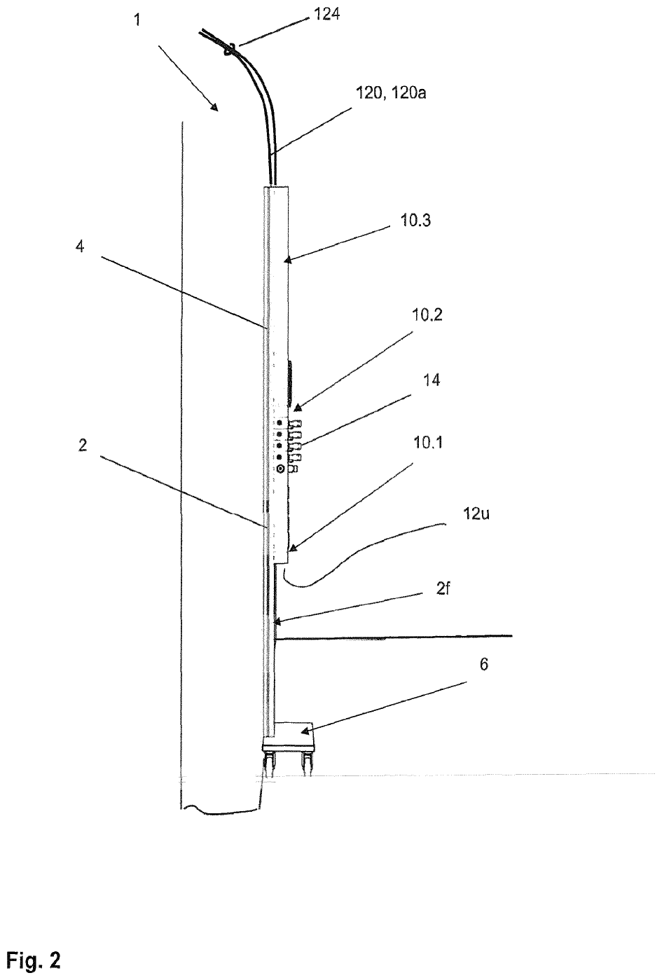

FIG. 2 is a schematic side view of the media column from FIG. 1, which is arranged in front of a wall,

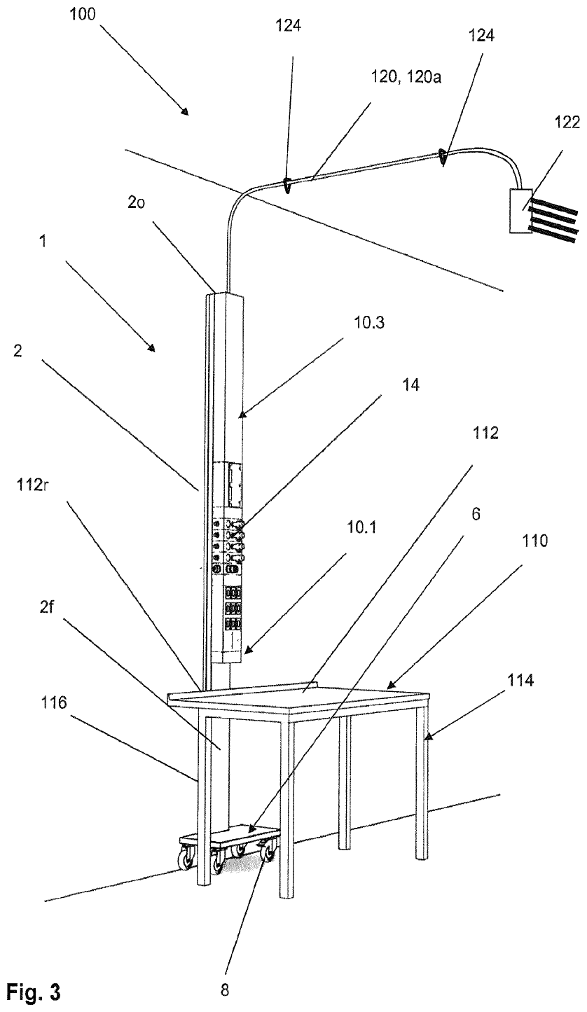

FIG. 3 is a schematic three-dimensional view of the media column from FIG. 1 in conjunction with a workbench arranged in front thereof,

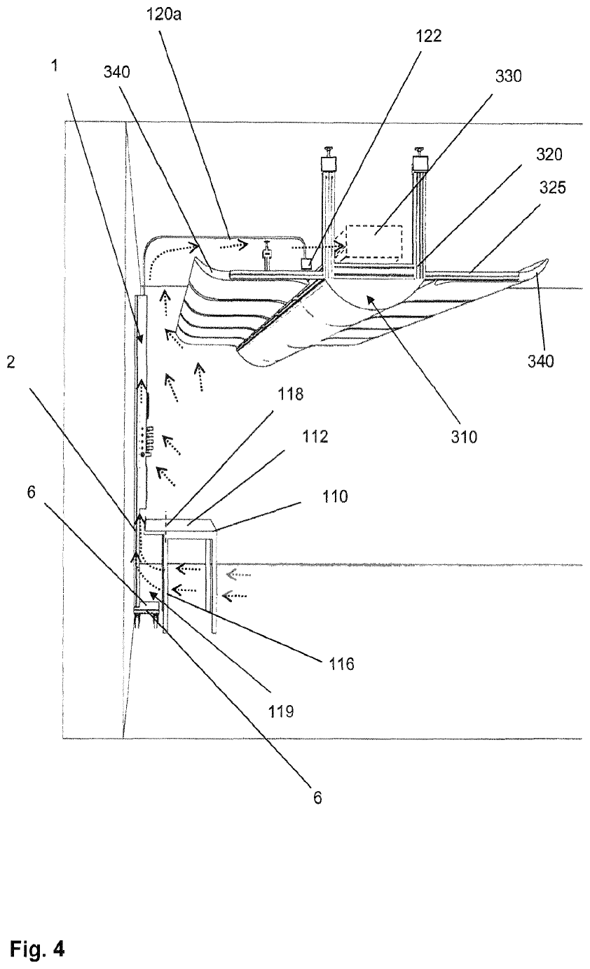

FIG. 4 is a schematic three-dimensional view of a laboratory comprising a ventilation assembly arranged on the laboratory ceiling, and a media column arranged between a building wall and a workbench, for illustrating the curved course of the supply lines,

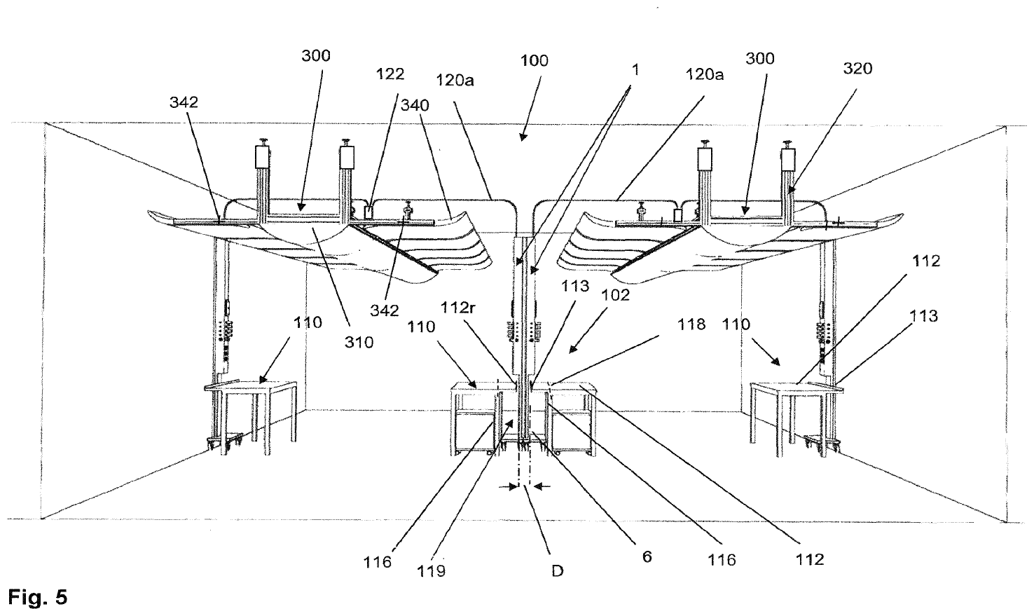

FIG. 5 is a schematic view of a laboratory comprising two ventilation assemblies received on the building ceiling, comprising a central supply air channel air outlet and air baffles protruding horizontally from this, on both sides, as well as two workbenches arranged back-to-back in the centre between the two ventilation assemblies and having media columns according to the invention positioned therebetween,

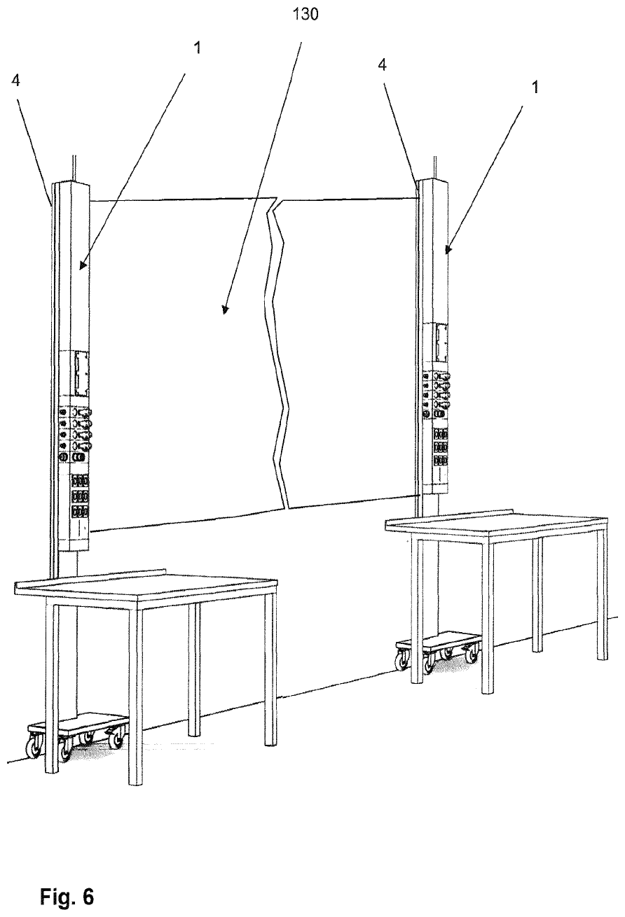

FIG. 6 shows a further embodiment of the invention, in which two media columns according to the invention, arranged behind a workbench in each case, are used as retaining devices for a planar separating element which is received having its vertical edges in mutually opposing longitudinal grooves of the inherently rigid profiles, and

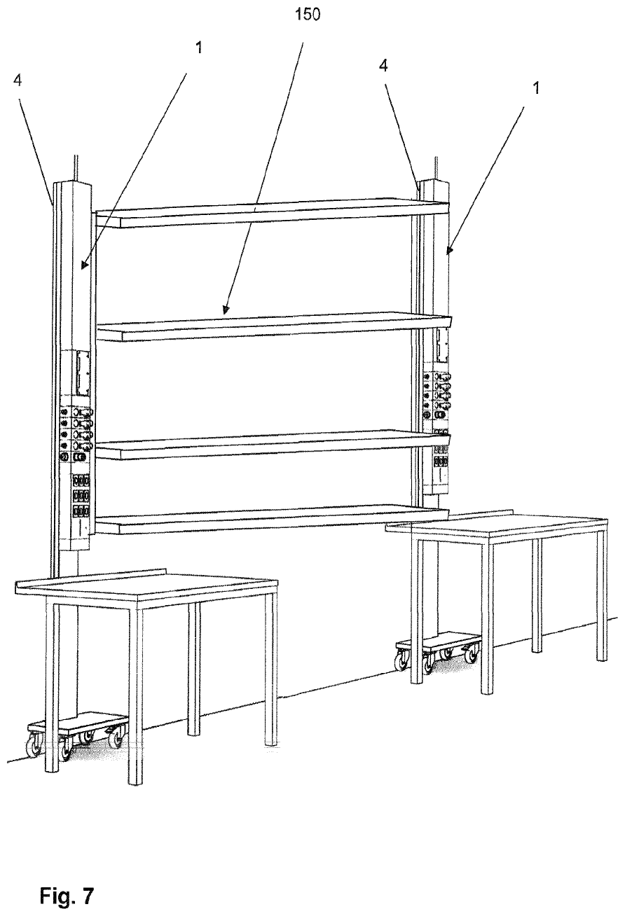

FIG. 7 shows a further embodiment of the invention, in which two media columns according to the invention, arranged behind a workbench in each case, are used as retaining devices for a shelf.

As shown in FIGS. 1 to 6, a media column 1 for distributing gaseous and/or liquid media in a laboratory comprises a carrier body 2 which extends in the vertical direction and on the front side 2f of which at least one module element 10, but preferably a plurality of module elements 10.1, 10.2 and 10.3, are detachably fastened one above the other, to which elements the media, such as gaseous and liquid media, e.g. technical gases, compressed air, and water, coolant and a vacuum, as well as electrical power and communication, are supplied via corresponding supply lines 120.

Each of the modules 10 has a housing 12 comprising a front side 12f, in which at least one extraction fitting 14 or a plug or a data interface, e.g. an ethernet network plug, is received, via which media can be output.

As is shown in detail in FIGS. 1 and 2, the carrier body consists of a flat, inherently rigid profile 2 which is elongated in the vertical direction and which preferably has a solid profile which is rectangular in cross-section and is made of metal, in particular aluminium or stainless steel. Said profile is fastened at its first lower end 2u so as to stand on the upper side of a standing platform 6, for which purpose the lower end face of the profile can be screwed and/or welded to the standing platform.

As is further shown in the illustrations of FIGS. 3, 4 and 5, the laboratory 100, in which the media column 1 according to the invention is used, comprises a plurality of workbenches 110 which each have a worktop 112 having a rear longitudinal edge 112r. The workbenches 110 are arranged, in the laboratory 100, in a known manner in rows extending in parallel with the aisle regions, which rows, however, are not shown in the drawings for the sake of clarity. Above the aisle regions of the laboratory 100, ventilation assemblies 300 are fastened on the ceiling of the laboratory room, which ventilation assemblies, as shown in FIGS. 4 and 5, have a central combined supply air channel/air outlet 310, which is suspended on the underside of a horizontally extending frame 320 or ceiling grid composed of support profiles, and preferably extends centrally along each aisle region of the laboratory 100. As can be furthermore seen, in this case, from the illustrations of FIGS. 4 and 5, at least one ceiling-side supply point 122, which is fed via a central supply (not shown in further detail) for the different media, is arranged above each combined supply air channel/air outlet 310, which is also referred to in the following as a supply air channel. For the sake of clarity, the individual supply lines 120 for the different media, such as inert gases, compressed air, water, and coolant, as well as electricity, etc., are shown in the drawings only as two individual schematic lines, and generally comprise an entire bundle of pipelines, guided in parallel with one another, as well as also cables and flexible hoses, depending on the required media.

As can be seen most clearly in FIG. 3, each of the workbenches 100, which are preferably standard laboratory workbenches, comprises a worktop 112 which has a rear longitudinal edge 112r that protrudes beyond the framework 114 of the workbenches 110. In this case, the distance by which the worktop 112 protrudes beyond an imaginary connecting line 118 that connects the two rear bench legs 116 of the benches 110 (FIGS. 4 and 5) is in the region of preferably approximately 30 cm, and therefore a usable free space 119 is provided under the rear longitudinal edge 112r of each workbench 110, which free space, in the case of workbenches 110,p positioned having their back on one of the building walls of the laboratory 100, is of a depth of approximately 30 cm. In the case of the workbenches 110 shown in FIG. 5 in the centre of the laboratory room 100 and positioned back-to-back, the free space 119 is of a width of preferably more than 60 cm.

As can furthermore be seen from the illustration of FIGS. 3 to 6, in the media columns 1 according to the invention the lowest module element 10.1 is positioned on the front side 2f of the inherently rigid profile 2, depending on the respective working height of the worktop 112 of a workbench 110, in such a way that the underside 12u of the approximately 160 mm deep housing 12 of the module element 10.1 is located at a small distance, for example a distance of 0.5 cm to 50 cm, above the respective worktop 112 of the workbench 110 in question, and the housing 12 of the lowest module element 10 protrudes beyond the worktop 112. This provides the possibility that the media columns 1 according to the invention can be freely shifted along the rear longitudinal edges 112r of the respective worktops 112 of the workbenches 110 in a space-saving manner, in order to place the media columns 1 at a desired location on the rear side of the workbenches 110.

In order to in this case allow a movement path of for example 1 to 3 m along the rear longitudinal edges 112r of the workbenches 110, without having to change the length of the supply lines 120 for the media in a complex manner by shortening or by inserting adapter parts, it is provided, according to the invention, for the supply lines 120 for the media to comprise flexible line portions 120a which can be guided from the second upper end 20 of the inherently rigid profile 2, in a curved manner, to a ceiling-side supply point 122 for the gaseous and/or liquid media.

Although the module elements 10 are preferably arranged above the worktops 112 of the workbenches 110, according to an embodiment that is not shown in greater detail it can also be provided that additionally one or more modules are received under the worktops 112 on the inherently rigid profile 2, in order to supply laboratory equipment (not shown) with the required media. In this case, the supply lines to the module elements 10 arranged under the worktops 112 preferably extend over the front side 2f of the inherently rigid profile 2, which can, for this purpose, be covered in this region with a flat covering.

In order to further facilitate the relocation of the media columns 1 in the case of a rearrangement of a workplace, it is provided in the preferred embodiment of the invention that the standing platform 2 comprises rollers 8 on its underside, as shown in the drawings, the axes of rotation of which rollers are fixedly arranged on the standing platform 6, such that the rotation planes of the rollers 8 extend in parallel with the front side 2f of the inherently rigid profile 2. This results in the advantage that the relevant media column 1 can always move along the rear longitudinal edge 112r of a workbench 110 in a straight line and with little force outlay, without having to raise the standing platform 6, as is necessary in the case of a simplified embodiment in which the underside of the standing platform 6 is planar and does not comprise any rollers.

Although in the embodiment of the media column 1 shown in the drawings the rollers 8 are configured as rollers which are screwed directly onto the underside of the standing platform 6, according to a further alternative embodiment of the invention it is particularly advantageous for the standing platform 6 to be thicker and to preferably comprise four rollers, which are configured having a smaller diameter and are received sunk into corresponding recesses, in the underside of the standing platform 6, such that the underside of the rollers protrudes beyond the standing platform 6 only slightly, for example by 1 mm. This integral arrangement of the rollers 8 in associated recesses on the underside of the standing platform 6 results in a particularly elegant design of the media column 1 in conjunction with increased structural stability. In this embodiment, it may also be advantageous for the recesses to be made in the corner regions of the standing platform 6 and for the rollers to extend, with their peripheral surfaces, only laterally by e.g. 1-2 mm beyond the edges of the platform, such that the peripheral surfaces of the rollers 8 come into contact with the floor only by slight lateral tilting of the media columns 1 by e.g. 20°, and the media columns 1 can be shifted. The structural stability of the media columns 1 can be further improved thereby.

According to a further concept on which the invention is based, the elongated, flat, inherently rigid profile 2 is fastened to the rear side 6r of the standing platform 6, such that the rear side of the inherently rigid profile 2 preferably extends flush with the rear edge of the standing platform 6. This results in the advantage that the front portion 6f of the standing platform 6 opposite the rear side 6r thereof can be arranged under the worktop 112 of a workbench 110 when the front side 2f of the elongated, inherently rigid profile 2 is resting on the rear longitudinal edge 112r of the worktop 112 in question. As a result, an optimal use of space of the free space 119 provided under the rear longitudinal edge 112r of the worktops 112 is achieved, and the additional space requirement is reduced, by the media column 1 according to the invention, merely to the depth of the inherently rigid, vertical profile plus a safety distance of for example 5 to 10 mm, which ensures that the front side 2f of the inherently rigid profile 2 does not contact the rear longitudinal edge 112r of a workbench 110 when the media column 1 is used, and is not damaged thereby.

It can furthermore be provided that, in a further embodiment of the invention, the elongated, inherently rigid profile 2 comprises grooves (not shown in further detail in the drawings) in the region of its front side, which grooves extend in the longitudinal direction of the profile 2, and that complementary engagement elements, in particular protrusions or latching lugs, are formed on the housing 12, by means of which the housing 12 can preferably be latched into the grooves without tools. This results in the advantage that the module elements 10 can be moved, in a very short time, to a desired position, in the longitudinal direction of the elongated, inherently rigid profile 2, in order, for example in the case of a workbench 110 having a worktop 112 that can be adjusted in a variable manner in height, to be able to adjust the distance between the underside 12u of the housing 12 of the lowest module element 10.1, in a very short time and without tools, to a new working height.

For this purpose, the housings 12 of the module elements 10 consist of an inherently rigid but reversibly deformable material, e.g. aluminium or stainless steel, and preferably have a U-shaped cross-section, which surrounds the front side 2f of the inherently rigid, elongated profile 2, forming a peripherally closed cavity, in the interior of which the supply lines 120 for the media are guided from the second upper end 20 of the carrier body to the extraction fittings 14 of the respective module elements 10. By pressing together the two free limbs of the U-shaped housing, the rear longitudinal edges thereof can be inserted into the grooves on the front side 2f of the profile 2, in which they are fixed by a frictional connection, after release of the pressure on the outsides of the two limbs, by the restoring forces.

As has already been stated above, preferably two or more module elements 10.1, 10.2 for the same or also for different media and/or for electricity and data are detachably received, positioned one above the other, on the elongated, inherently rigid profile 2, the housings 12 of which module elements, as shown in FIG. 3, rest against one another with their underside and upper side, such that a continuous surface results to the outside, in which the connections of the extraction fittings 14 are arranged.

In order to further improve the visual appearance, optimised in this way, of the media column according to the invention, a blind module 10.3 is arranged above the uppermost module element 10.2, which contains an extraction fitting 14, which blind module has a housing that is likewise U-shaped in cross-section and which, in cross-sectional shape, preferably substantially corresponds to the shape of the U-shaped housing 12 of the remaining module elements 10. Said blind module 10.3 extends, as shown for example in FIG. 3, as far as the second upper end 20 of the inherently rigid profile 2, and covers the supply lines 120 (not shown in further detail) which are fastened thereto and which are guided in the interior of the housing 12 from the upper end 20 of the inherently rigid profile 2 as far as the respective extraction fittings 14.

According to a further concept on which the invention is based, it can furthermore be provided for at least one flexible supply line 120 for the media, but preferably a plurality of supply lines 120, to be guided from the second upper end 20 of the inherently rigid, elongated profile 2, in a curved manner, to the ceiling-side supply point 122, which is preferably arranged on the top of the supply air channels 310, as is shown in the illustration of FIG. 5. In order here, in the case of lines which, although flexible, do not have the necessary inherent rigidity for ensuring the shown curved guidance thereof in the region between the ceiling-side supply point 122 and the respective media column 1, it is provided, according to a further embodiment of the invention, for the lines to be movably interconnected by connection means 124 indicated in FIG. 3, such as cable ties and/or clips, at at least one, but preferably at a plurality of, connection point(s), in a form-fitting manner viewed in the peripheral direction of the flexible supply line portions 120a and with a friction fit viewed in the longitudinal direction of the flexible supply line portions 120a. This results in the advantage that the area of moment inertia of the wiring harness consisting of a plurality of lines can be increased significantly with minimal material being required, such that these do not bend on account of gravity and therefore retain their curved shape. Nonetheless, on account of the displaceability, remaining as before, of the lines relative to one another in the longitudinal direction, this embodiment advantageously allows for a comparatively large displacement path of the media columns 1 according to the invention relative to the rear longitudinal edges 112r of the workbenches 110 which, depending on the distance between the supply point 122 and the respective media column, can be up to 2.5 m or even more, without additional lengthening of the line portions being required.

According to a further concept of the invention, an assembly 102 of workbenches 110 in a laboratory 100 comprising at least one workbench 110 which has a worktop 112 having a rear longitudinal edge 112r, is characterised in that said assembly comprises at least one media column 1 as described above which is arranged having the front side 2f of the inherently rigid, elongated profile 2 close to the rear longitudinal edge 112r of the worktop 112 of the workbench 110, in such a way that the housing 12 of the lowest module element 10u extends above the upper side of the worktop 112 and the media column 1 can be moved to different positions, in the lateral direction along the rear longitudinal edge 112r of the worktop 112 of the associated workbench 110.

As can be seen in this case from the illustration of FIG. 5, in a preferred embodiment the assembly 102 comprises at least two workbenches 110 that are positioned back-to-back relative to one another and two media columns 1 arranged back-to-back therebetween. In this case, the clear distance D between the rear longitudinal edges 112r of the two workbenches 110 is preferably greater than twice the depth of the inherently rigid elongated vertical profile 2 of the media column 1 at the height of the rear longitudinal edges 112r of the worktops 112.

As has already been described above, the workbenches 110, which are preferably all configured identically in a laboratory room 100, comprise a framework 114 having in each case 2 rear bench legs 116 and a worktop 112, which extends, in the horizontal direction, beyond the imaginary connecting line 118 between the two rear bench legs 116, such that a free space 119 results under the rear longitudinal edge 112r of each workbench 110, in which free space the standing platform 6 can be moved in a collision-free manner when the media column 1 is displaced along the rear longitudinal edge 112r. In the case of workbenches 110 arranged along rows, it can also be provided in this case that, instead of a workbench 110, a large item of equipment is arranged between two neighbouring adjoining benches 110.

As has further been acknowledged by the applicant, it is a particular advantage here if the free space 119 provided under the worktop 112 between the rear longitudinal edge 112r of a workbench 110 and the two rear bench legs 116 is configured to receive an item of laboratory equipment or an item of furniture, preferably of a standard width of 60 cm, in order to use the free space 119 and to close it in the lateral direction by the inserted laboratory equipment or item of furniture (not shown), in particular when the two workbenches 110 are positioned back-to-back, according to the embodiment of FIG. 5, and the free space 119 is thus twice the width plus twice the depth of the profiles 2 of e.g. 60 mm.

As a result of the above-described clear distance D between the rear longitudinal edges 112r of the workbenches 110 arranged back-to-back in parallel rows, or the distance or gap, provided by the depth of the inherently rigid profile 2, between thee benches 110 and an adjacent wall of the laboratory 100, laboratory equipment, arranged under the bench, can be supplied from above the benchtop 112, with the respective media from the media columns 1 according to the invention. This preferably takes place in that the flexible supply and removal lines for the respective media to the laboratory equipment or also EDP devices arranged under the workbenches 110 and also on said benches are advantageously supplied via hoses and/or cables laid in a tubular manner, which are guided through the gap. In this case, the curved or tubular guidance of the supply and removal lines through the gap formed along the longitudinal edges 112r makes it possible to provide a line reservoir, as it were, which further facilitates the lateral displacement of the media columns 1 according to the invention. Thus, for example by providing a loop which is guided to the floor and up again to the corresponding media module of the media column 1, through the gap, a sufficiently large supply line clearance can be achieved, which makes it possible that the relevant workbench 110, together with an item of laboratory equipment located thereon, can be pulled forward out of the row of benches and into the aisle region, without separating the supply and removal lines. This allows for simple access to the rear of the laboratory equipment for maintenance or repair work, for which sometimes heavy equipment otherwise has to be completely separated from the supply lines and raised from the benches 110 via corresponding lifting devices.

Since in this case the media lines extend, in a manner bundled straight to the rear, downwards via the rear longitudinal edges 112r of the workbenches 110, said lines no longer rest loosely on the worktops 112 of the benches as loops, behind the devices. This ensures neatness and allows for easier cleaning of the bench surfaces.

In order to provide a particularly reliable, efficient and pleasant airflow within the laboratory 100 in the region of the workbenches 110, in conjunction with the ventilation assembly 300 shown in FIGS. 4 and 5, it can furthermore be provided that the worktops 112 of the workbenches 110, which are preferably arranged along rows (not shown in greater detail) extending in parallel, on both sides of the central supply air channels 310 of the ventilation assemblies 300, comprise a nose or lip 113 which deflects an airflow, rising up from the region under the worktop 112, in the vertical direction, in the manner of a spoiler, such that said airflow can rise up optimally. As the inventor has found, this can advantageously further reduce the energy requirement for providing the air exchange required in a laboratory. As the applicant has also identified, the space under the worktops 112 of the benches 110 is also covered and rinsed by said airflow.

Furthermore, as shown in FIG. 6, longitudinal grooves 4 for receiving the vertically extending lateral edges of planar separating elements 130 can be formed in the lateral end faces of the elongated vertical profile 2 of the media columns 1, which separating elements can be arranged between the inherently rigid profiles 2 of two media columns 1 positioned at a distance from one another, in order to spatially separate the work regions as a splashback, in particular in the case of the workbenches 110 positioned back-to-back, shown in FIG. 5.

As is furthermore shown in FIG. 7, the previously mentioned longitudinal grooves 4 can also be used to receive fastening elements (not shown in greater detail) for shelves 150, on which fastening elements for example the bases of the shelves 150 can be fastened. The fastening elements can for example be flattened metal brackets having crossbars formed thereon, which are mechanically fixed, in particular clamped, in the longitudinal grooves 4 after being inserted therein.

In the case of the last-described embodiment of the invention, it can furthermore be provided that the media columns 1 are arranged, also back-to-back in pairs, on workbenches 110 arranged opposite one another and back-to-back, and are screwed together or interconnected in a form-fitting manner by clamping devices or clasps I order to increase the stability. In this way, if required mobile shelf assemblies can be created in a very short time, using the media columns 1 according to the invention, comprising shelves 150 which are displaceable along the longitudinal edges 112r of the workbenches 110 and offer increased stability against falling over.

According to a further concept on which the invention is based, the laboratory 100 or the assembly 102 of workbenches 110 contained therein comprises a ventilation assembly 300 that is arranged above the workbenches 110 and comprises a central combined supply air channel/air outlet 310, which is also referred to in the following as a central supply air channel, and an exhaust air channel 330 arranged thereabove. The central supply air channel 310 and the exhaust air channel arranged thereabove, which is indicated merely schematically in FIG. 4, are received on a frame 320 of support profiles, above the workbenches 110, which frame is fastened to the ceiling of the laboratory room via vertical profiles. The frame 320 comprises horizontal profile carrier members 325 which are opposite one another in pairs and extend away from the central supply air channel 310, to the side, on both sides, and between or on which air guiding panels 340 are received. As can be seen from the illustrations of FIGS. 4 and 5, the air guiding panels 340 have a downwardly curved, air-guiding surface in the form of a horizontal, flattened S, of which in each case one longitudinal edge originates in the region above the associated central supply air channel 310, and the other free longitudinal edge, as shown, is angled in the upwards direction. By means of this upwardly angled, curved shape of the free panel edges, which edges are located in the region above the rear longitudinal edges 112r of the workbenches 110 and form a continuous air guiding surface, the heated air, which is heated under the workbenches 110 by laboratory equipment and/or EDP devices (not shown) and rises up through the gap formed along the rear longitudinal edges 112r of the workbenches 110, is deflected away from the central supply air channel 310 in the upwards direction, into the room region above the air guiding panels 340.

As was acknowledged by the applicant, this advantageous design, which is S-shaped in a wing-like or lever-like manner, of the air guiding panels 340 arranged on both sides of the central supply air channel 310, in conjunction with the gap defined between the rear longitudinal edges to 112r of the workbenches 110 by the depth of the inherently rigid profile, results in a flow of heated air that is directed in the upwards direction. This is indicated in FIG. 4 by the arrows, and ensures, in conjunction with the curved shape of the panel edges, directed in the upwards direction, a particularly effective separation of the heated rising exhaust air form the cooled and/or cleaned supply air that is supplied via the central supply air channels 310. As was acknowledged by the applicant, the energy requirement for providing the fresh air supplied via the central supply air channels 310, which is suctioned off again via the respective exhaust air channel 330 arranged above the air guiding panels 340, can advantageously be significantly reduced as a result. The exhaust air channels 330 are not shown in the illustration of FIG. 5, for the sake of clarity.

According to a further embodiment, the air guiding panels 340, which can alternatively also be used without an above-described displaceable media column 1, in a laboratory 100, which comprises an assembly 102 of workbenches 110 having worktops 112, the rear longitudinal edges 112a of which are separated from one another or from an adjacent vertical wall by a gap, advantageously consist of a foamed, sound-absorbing plastics material. As a result, the otherwise disruptive reverberation times of sound, which propagates in conventional laboratories with little damping, on account of the large number of hard surfaces of the workbenches and other laboratory installations, can advantageously be significantly reduced.

Furthermore, in the case of the last-described embodiment of the invention, it can be provided that the air guiding panels 340 are preferably foldable downwards, with their angled, outer ends, about pivot axes 342 merely indicated in FIG. 5, in order, upon shifting of the media columns 1, to achieve access to the supply lines 120 or their flexible line portions 120a, and also to the ceiling-side supply points 122, within an extremely short time. This offers the possibility of, if necessary, re-laying or transferring the supply lines 120 that are preferably connected by means of quick couplings to the extraction fittings 14 of the module elements 12 and the ceiling-side supply point 112, and of removing supply lines that are not required.

In order to fix the air guiding panels 340 in their horizontal working positions, shown in FIGS. 4 and 5, said panels can be provide with latching means (not shown in greater detail), e.g. spring-loaded, displaceable locking bolts, displaceable, spring-loaded locking balls, or the like, or also magnet means, such as permanent magnets, which are fastened to the lateral edges of the air guiding panels 340 and interact with corresponding complementary mating means on the horizontal profile supports 325. The latching means and complementary mating means (not shown in further detail) can also be arranged in the reverse manner on the profile supports 325 and the air guiding panels 340, and make it possible that the air guiding panels 340 can preferably be released, and pivoted in the upwards direction, by hand, without tools.

### LIST OF REFERENCE SIGNS

1 media column
2 carrier body/elongated, inherently rigid profile
2u first, lower end of the inherently rigid profile
2f front side of the inherently rigid profile
2o upper end of the carrier body
4 longitudinal grooves in lateral end faces of the inherently rigid profile
6 standing platform
6r rear side of the standing platform
6f front-side portion of the standing platform
8 rollers
10 module element
10.1 first module element
10.2 second module element
10.3 blind module
12 housing of the module element
12u underside of the housing
14 extraction fitting
100 laboratory
102 assembly of workbenches
110 workbench
112 worktop
112r rear longitudinal edge of the worktop
113 nose or lip on rear longitudinal edge
114 framework of the workbenches
116 rear bench legs
118 imaginary connecting line between the rear bench legs
119 free space
120 supply lines for the media
120a flexible supply line portions
122 ceiling-side supply point
124 connection means
130 planar separating element
150 shelf
300 ventilation assembly
310 central supply air channel
320 frame composed of support profiles
330 exhaust air channel
340 air guiding panel having a panel edge that is angled in the upwards direction
342 pivot axis
D clear distance between the rear longitudinal edges of two workbenches arranged back-to-back

1-15. (canceled)

16. A media column for distributing media, the media column (1) comprising:
at least one workbench having a worktop with a rear longitudinal edge;
a carrier body extending in a vertical direction and at least one detachably fastened module element on a front side;
at least one supply line configured to supply media to said at least one detachably fastened module element;
a housing of said at least one detachably fastened module element having a front side with at least one extraction fitting, said extraction fitting being configured to output the media;
said carrier body having a flat rigid profile being elongated in the vertical direction;
a platform, said carrier profile being fastened at a first lower end of said carrier profile on an upper side of a standing platform,
said at least one module element being on the front side of the inherently rigid profile and at a distance from the upper side of the standing platform such that the underside of the housing is vertically adjacent said worktop of said at least one workbench and the housing protrudes over the worktop perpendicular to the rear longitudinal edge; and
said at least one supply line for the media having flexible line portions configured to be guided in a curved manner from a second upper end of said carrier profile to a ceiling-side supply point of media.

17. The media column according to claim 16, further comprising rollers fixedly attached on an underside of said standing platform, and said rollers having a rotation plane parallel with the front side of the rigid profile.

18. The media column according to claim 16, wherein said rigid profile is fastened to a rear side of said standing platform, a front portion of the standing platform opposite said rear side is configured to extend under said worktop of said at least one workbench, and the front side of the rigid profile is configured to rest on said rear longitudinal edge of said worktop.

19. The media column according to claim 16, further comprising:
grooves at a region of a front side of the rigid profile, said grooves extending in the longitudinal direction of said rigid profile; and
complementary engagement elements on the housing, said housing being latched into the grooves without tools.

20. The media column according to claim 16, wherein said housing of the module elements has a U-shaped cross-section which surrounds the front side of said rigid profile and forms a peripherally closed cavity, and said at least one supply line is guided in an interior of the peripherally closed cavity from said second upper end of the carrier body to said extraction fittings.

21. The media column according to claim 16, further comprising:
at least two further module elements detachably attached to the rigid profile, said at least two further module elements being arranged one above the other, and housings of said at least two further module elements adjoin one another; and/or
a dummy module, having a cross-sectional shape that corresponds to the shape of the U-shaped housing, on the front side of the rigid profile, and said dummy module extending as far as the second upper end of the profile and optically conceals the front side of the inherently rigid profile, and the supply lines.

22. The media column according to claim 16, wherein said at least one supply line is two or more supply lines, and the media column further comprises connectors connecting at least two flexible portions (120a) of the supply lines, said connectors being movably interconnected in a form-fitting manner around a peripheral of the flexible line portions and/or with a friction in the longitudinal direction of the flexible line portions.

23. An assembly of workbenches for a laboratory, the assembly comprising:
at least one workbench having a worktop with a rear longitudinal edge;
at least one media column according to claim 16 having said front side of the rigid profile adjacent the rear longitudinal edge of the worktop of the workbench; and
said housing of a lowest module element extending above the upper side of the worktop, and said media column being moveable to different positions, in a lateral direction along the rear longitudinal edge of the worktop of the workbench.

24. The assembly according to claim 23, wherein:
said at least one workbench is two workbenches and said at least one media column is two media columns;
said two workbenches are positioned back-to-back and said two media columns are arranged back-to-back between said two workbenches;
a clearance distance is arranged between the rear longitudinal edges of the two workbenches and is greater than twice the depth of the rigid profile of the carrier body at a height of the rear longitudinal edges of the worktops.

25. The assembly according to either claim 23, wherein the workbench has a framework with two rear bench legs, and the worktop of the workbench extends, in the horizontal direction, beyond an imaginary connecting line between the two rear bench legs, such that a free space results under the rear longitudinal edge of the workbench, and the standing platform is configured to be moved in the free space in a collision-free manner when the media column is displaced along the rear longitudinal edge.

26. The assembly according to claim 25, wherein the free space under the worktop is configured to receive an item of laboratory equipment or a piece of furniture to close the free space in the lateral direction.

27. The assembly according to any of claims 23, wherein the worktop of the workbench has a nose or lip extending in the upwards direction in a region of the rear longitudinal edges, and the nose or lip is configured to deflect an airflow, rising up from the region under the worktop, in the vertical direction.

28. The assembly according to any of claims 24, further comprising longitudinal grooves configured for receiving fasteners for planar separating elements, said longitudinal grooves being formed in the lateral end faces of the rigid profile of the media column, said separating elements are fastened between the rigid profiles of two media columns arranged at a distance from one another, for spatially separating a working region of the laboratory.

29. The assembly according to any of claims 24, further comprising longitudinal grooves configured for receiving fastening elements for shelves being formed in the lateral end faces of the rigid profile of the media column, said shelves being fastened between the rigid profiles of two media columns arranged at a distance from one another.

30. The assembly according to any of claim 24, further comprising:
a ventilation assembly that is arranged above the workbenches and has a central combined supply air channel and air outlet, and an exhaust air channel arranged above the combined supply air channel and air outlet;
said combined supply air channel and air outlet and said exhaust air channel being arranged above the workbenches on a frame of support profiles; and
air guiding panels having panel edges angled in the upwards direction are arranged to the side of the central supply air channel, and air guiding panels are configured to deflect the air, heated under the workbenches by laboratory equipment and/or EDP devices away from the central supply air channel, in an upwards direction, into a room region above the air guiding panels.

31. The media column according to claim 16, wherein the media is selected from the group consisting of gas, liquid, vacuum, power, and communication in a laboratory, and said carrier profile is a metal profile.

32. The media column according to claim 19, wherein said engagement elements are protrusions or latching lugs.

33. The media column according to claim 21, wherein the at least two further module elements are configured for mutual different media and/or for electricity.

34. The media column according to claim 22, wherein said connectors are cable ties and/or clips.

35. The media column according to claim 30, wherein said air guiding panels have sound-absorbing plastics foam and/or are received on the frame by respective free ends such that they can be folded down about a pivot axis, and the air guiding panels are configured to direct the air up through the gap provided in the profile.
